(19) United States
(12) Patent Application Publication
(10) Pub. No.: US 2003/0030185 A1
(43) Pub. Date: Feb. 13, 2003

(54) Compression molding apparatus and method

(76) Inventor: George J. Gemberling, Sleepy Hollow, IL (US)

Correspondence Address: Douglas B. White & Associates, 1000 East Woodfield Rd. # 102, Schaumburg, IL, 60173, US

(21) Appl. No.: 10/223,521

(22) Filed: Aug. 19, 2002

Related U.S. Application Data
(62) Division of application No. 09/706,928, filed on Nov. 6, 2000.

(51) Int. Cl. B29C 43/00

(52) U.S. Cl. 264/325; 264/334

(57) ABSTRACT

The apparatus includes a mold core, a mold cavity and a moveable ring surrounding the mold cavity. A graphite/resin mixture is loaded into the mold cavity, filling a well area defined by the ring. The mold core is then pressed against the mixture in the mold cavity and heat is applied to harden the resin. The mold core is then raised, the ring is lowered, and the finished part is ejected.

### CROSS REFERENCE TO RELATED APPLICATIONS

This application is a Divisional of a prior application Ser. No. 09/706,928.

### STATEMENT REGARDING FEDERALLY SPONSORED RESEARCH OR DEVELOPMENT

Not Applicable

### BACKGROUND OF THE INVENTION

1. Field of the Invention

The present invention relates generally to apparatus and methods for the compression molding of parts using thermosetting resins. More particularly, this invention relates to apparatus and methods developed for the compression molding of graphite plates used in the fuel cell industry.

2. Description of the Prior Art

Fuel cells employing graphite plates for the electrochemical production of electricity from hydrogen are well known. Graphite plates are used as electrodes in these fuel cells, and similar chemical reactive devices, and have been constructed by a variety of prior art methods in an attempt to produce effective and economical devices. One such method, described in U.S. Pat. No. 4,165,349, includes forming the graphite plate by molding the plate from a mixture of carbon fibers and thermosetting resin.

Compression molding of products using thermosetting resins that harden under heat and pressure is well known, but compression molding of a mixture of graphite and thermosetting resin for graphite plates has presented a number of difficulties. Typical compression molding materials are putty-like in consistency. As a result they are easy to measure, preform and insert into a mold. Moreover, during compression, typical molding materials spread out evenly in the mold, equalizing the density of the molded part, and shrink, automatically releasing the molded part from the sides of the mold and making it easy to eject the finished part.

In contrast, the graphite/resin mixture used for production of graphite plates is light and powdery in its pre-molded state and must be accurately measured directly into the mold cavity. During compression this material does not spread out in the mold cavity, and consequently any unevenness in the filling of the mold causes unevenness in the density of the finished part. Finally, this graphite/resin molding material expands during molding, causing the finished part to fit tightly within the mold. Since this graphite/resin plate is brittle and only about ⅛ inch in thickness, ejection of such a tight fitting part by typical ejection techniques is impractical.

### SUMMARY OF THE INVENTION

The object of the present invention is to provide an apparatus and method for facilitating the compression molding of graphite parts, such as a graphite fuel cell electrode plate, which are molded from a graphite/resin mixture. The apparatus includes a mold core, a mold cavity and a moveable ring surrounding the mold cavity. The graphite/resin mixture is first loaded into the mold cavity, filling a well defined by the ring and the mold cavity. The mold core is then forced against the mixture in the mold cavity and heat is applied to harden the resin. After the molded part has hardened, the mold is opened and the ring is lowered to expose the finished part, whereupon the part is ejected.

### BRIEF DESCRIPTION OF THE DRAWINGS

FIG. 1 is a cross sectional view of a molding apparatus in accordance with the present invention, showing the moveable ring in the upper position.

FIG. 2 is a perspective view of the mold cavity portion of the mold apparatus showing the moveable ring in its upper position.

FIG. 3 is a perspective view of the mold cavity portion of the mold apparatus with the moveable ring in its lowered position and with the finished part ready for ejection.

While the invention will be described in connection with a preferred embodiment of a compression molding apparatus and method of compression molding, it will be understood that it is not the intent to limit the invention to that embodiment. On the contrary, it is the intent to cover all alternatives, modifications, and equivalents as may be included within the spirit and scope of the invention as defined by the appended claims.

### DESCRIPTION OF THE PREFERRED EMBODIMENT

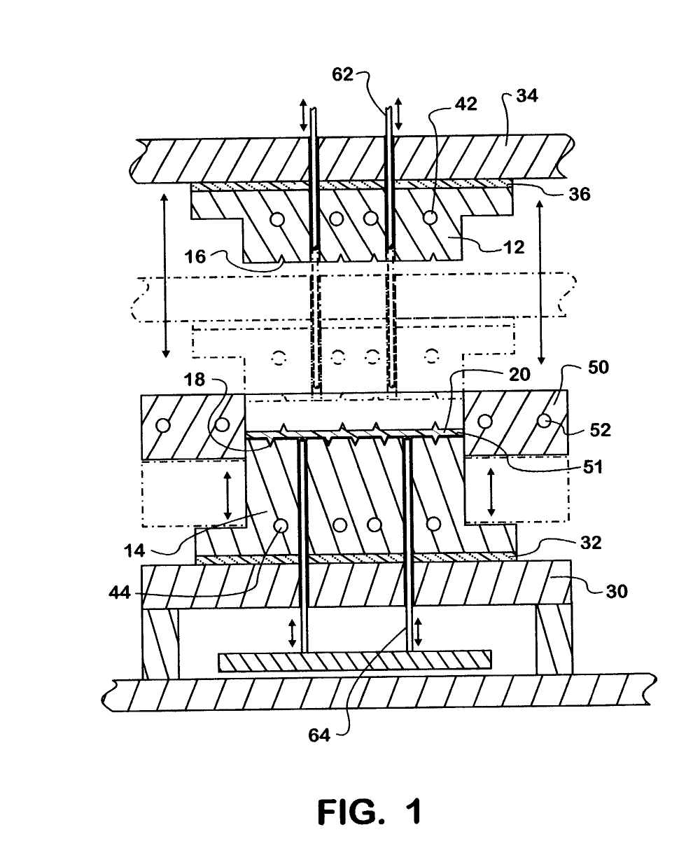

Turning first to FIG. 1 there is shown, in cross section, a compression molding apparatus in accordance with the present invention. The molding apparatus comprises an upper mold core member 12 and a lower mold cavity member 14. Upper details 16 and lower details 18 are provided in the mold core and mold cavity, respectively, to create the desired surface contours in the finished molded part 20.

The mold cavity 14 is shown positioned on a supporting base 30 and separated therefrom by an insulating layer 32. Similarly an upper plate member 34 supports the mold core 12 and is separated therefrom by an insulating layer 36. This upper plate member 34 serves to connect the mold core to compression means, such as a compression press (not shown). In response to pressure applied thereto by the compression means, the upper plate member acts to selectively move the mold core toward the mold cavity. As an equivalent alternative, in order to press the mold members together, the mold cavity may be moved toward the mold core, or both the mold core and the mold cavity may be moved.

When the mold core and the mold cavity are pressed together, molding material placed in the mold cavity is compressed to form the molded part 20. To cure the resin in the molding mixture and cause it to harden, the molded part 20 is simultaneously heated by means well known in the art for applying heat through the compression molding apparatus. Several prior art methods for applying heat comprise the use of steam, hot oil, or electric heaters, applied through channels provided in the mold core and mold cavity. In the preferred embodiment, such heat is applied to the mold core through a series of holes 42 and similarly applied to the mold cavity through a series of holes 44.

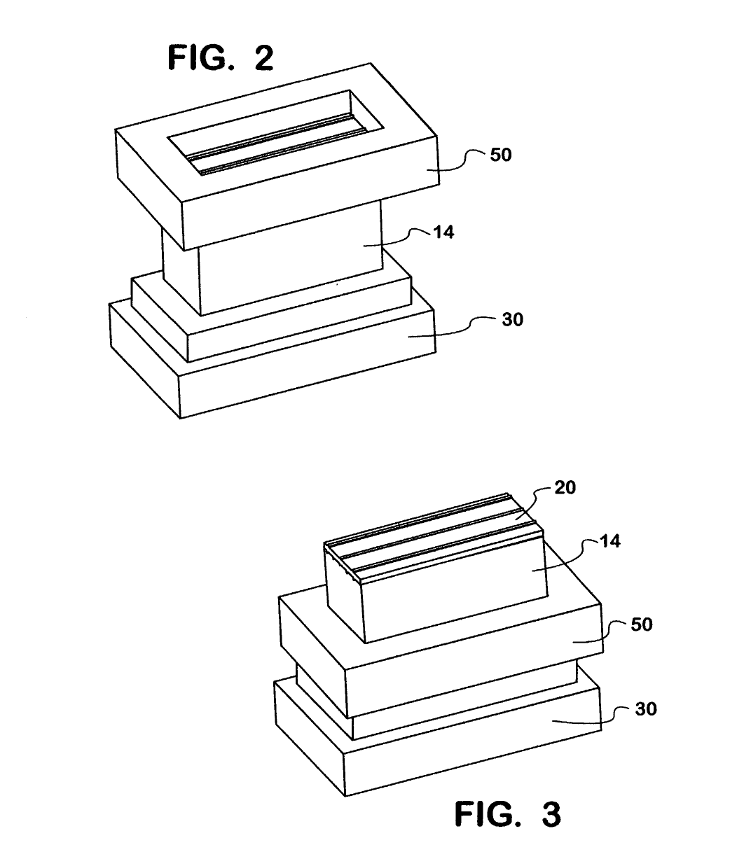

Prior to compression of the molded part 20, a ring member 50, having the shape of the periphery of the mold cavity 14, is first positioned to surround the peripheral rim 51 of the mold cavity. This ring member is arranged to selectively move between a first position (FIG. 1 and FIG. 2) surrounding the peripheral rim 51 of the mold cavity and a second position (shown in FIG. 3 and in phantom in FIG. 1) clear of the rim of the mold cavity.

In its first position, the ring member creates and defines an accurate well area within the ring and above the surface of the mold cavity for receipt of the graphite/resin molding material. To load the mold with the precise amount of molding material, the well area is simply filled and the molding material is leveled with the upper surface of the ring member. This provides an effective way to accurately measure and to evenly distribute the powdery molding material prior to compression, thereby guaranteeing a uniform molded product. Once the well area is filled, the mold core is forced into the well area, trapping and compressing the molding material between the mold core and the mold cavity. In the preferred embodiment, the ring member 50 is also provided with means for applying heat to the molded part during its formation. Particularly, heat is applied through the ring member via a series of holes 52, in the same manner as is used for the heating of the mold core and the mold cavity.

Following compression and heating of the molded part 20, the ring member 50 is moved to a position clear of the mold cavity rim area and of the molded part (see FIG. 3). Such a move may be accomplished with a one-piece ring by shifting the ring either upward or downward, or the ring may be split and the sections separated to facilitate the move. In the preferred embodiment the ring member is lowered, as shown in FIGS. 1 and 3, and means for moving the ring member may be either manual, mechanical, hydraulic, or any other equivalent means known to the art. By so moving the ring member, the sides of the finished part are freed from the mold and the finished part is exposed. This counteracts the tendency of the molded part to stick in the mold during the molding operation and lessens the force needed to eject the molded part 20.

In the preferred embodiment, before lowering the ring member 50, the mold core is first raised; that is, the mold core and the mold cavity are separated from each other. In doing so, if the molded part tends to stick to the mold core, ejection means is used to cause separation of the molded part 20 from the mold core 12. In the preferred embodiment, this ejection means comprises a plurality of selectively moveable rods 62 protruding through the mold core to push against the molded part. Once the ring member 50 has been moved, exposing the molded part, similar ejection means is employed for separating the molded part from the mold cavity. This ejection means likewise comprises a plurality of moveable rods 64 protruding through the mold cavity to push against the molded part and to separate the molded part 20 from the mold cavity 14.

From the foregoing description, it will be apparent that modifications can be made to the apparatus and method for using same without departing from the teachings of the present invention. Accordingly, the scope of the invention is only to be limited as necessitated by the accompanying claims.

What is claimed is:

1. A method of compression molding a molded part from molding material comprising the steps of:
providing a mold cavity, having a rim defined thereon, with a surrounding moveable ring member, wherein said ring member surrounds said rim of said mold cavity;
loading said mold cavity with molding material;
forcing a mold core against said mold cavity and said molding material placed therein, and compressing said molding material to form a molded part; and
moving said ring member to expose the molded part.

2. The method of claim 1 further comprising the step of ejecting said molded part.

3. The method of claim 1 further comprising defining with said ring member a well area for measuring a quantity of molding material into said mold cavity.

4. The method of claim 1 wherein said ring member is moveable between a first position surrounding said rim of said mold cavity and a second position clear of said rim of said mold cavity.

5. The method of claim 4 further comprising the step of heating said mold core, said mold cavity and said ring member.

6. The method of claim 2 wherein said step of ejecting said molded part comprises forcing a plurality of rods through said mold cavity and against said molded part to separate said molded part from said mold cavity.
